(19) United States
(12) Patent Application Publication
(10) Pub. No.: US 2021/0108551 A1
(43) Pub. Date: Apr. 15, 2021

(54) EXHAUST SYSTEM

(71) Applicant: Boondocker, Idaho Falls, ID (US)

(72) Inventors: Rocklund D. Young, Idaho Falls, ID (US); Rocklund D. Young, JR., Idaho Falls, ID (US)

(21) Appl. No.: 17/068,728

(22) Filed: Oct. 12, 2020

Related U.S. Application Data
(60) Provisional application No. 62/913,893, filed on Oct. 11, 2019.

(51) Int. Cl. F01N 13/08; G10K 11/16

(52) U.S. Cl. CPC F01N 13/085; G10K 11/161

(57) ABSTRACT

An exhaust system is disclosed. A method of providing the exhaust system is also included. A vehicle may implement the exhaust system. In certain examples, the exhaust system includes a muffler having an exhaust inlet and an exhaust outlet. The exhaust system also includes a housing disposed around the muffler. The housing includes, in certain examples, a first exhaust opening disposed adjacent the exhaust outlet and configured to receive exhaust gasses from the exhaust outlet and direct the exhaust gasses away from the exhaust system in a normal operating mode, and a second exhaust opening configured to draw in ambient air in the normal operating mode.

### CROSS-REFERENCES TO RELATED APPLICATIONS

This application claims the benefit of U.S. Provisional Patent Application No. 62/913,893 entitled “Exhaust System” and filed on Oct. 11, 2019 for Rocklund D. Young, et al., which is incorporated herein by reference.

### FIELD

This invention relates to exhaust systems for land vehicles, and more particularly relates to improved exhaust systems for internal combustion engines.

### BACKGROUND

Almost every internal combustion engine vehicle implements an exhaust system to direct exhaust gases away from the engine. One or more pipes direct the flow of the exhaust gases away from a cylinder head and through one or more of a turbocharger, catalytic converter, or a muffler.

Land vehicles that travel off-road take into consideration many factors when routing an exhaust system including performance, heat management, user safety, etc. In some off-road vehicles, such as snowmobiles for example, the exhaust is discharged through a port below the engine compartment. For example, in most snowmobiles an exhaust port is located in the floor of the engine compartment and generally on one side or the other.

However, when the snowmobile is ridden in deep snow, especially powder snow, the exhaust port can become clogged with snow and impair engine performance or even cause the engine to stall. Additionally, the engine compartment may become heated excessively and damage engine components and electronics contained in the engine compartment.

### SUMMARY

An exhaust system is disclosed. A method of providing the exhaust system is also included. A vehicle may implement the exhaust system. In certain examples, the exhaust system includes a muffler having an exhaust inlet and an exhaust outlet. The exhaust system also includes a housing disposed around the muffler. The housing includes, in certain examples, a first exhaust opening disposed adjacent the exhaust outlet and configured to receive exhaust gasses from the exhaust outlet and direct the exhaust gasses away from the exhaust system in a normal operating mode, and a second exhaust opening configured to draw in ambient air in the normal operating mode.

In certain examples, the exhaust system includes a gap between an end of the exhaust outlet and a plane defined by the first exhaust opening. The gap has a distance in a range of between about 0.25 and 5 inches. The second exhaust opening directs exhaust gasses away from the exhaust system in a blocked operating mode.

In certain examples, the exhaust outlet has a diameter, and the first exhaust opening has a diameter larger than the diameter of the exhaust outlet. The exhaust system may have a plurality of standoffs configured to maintain a distance between the muffler and the housing. In certain examples, the exhaust inlet is fluidly coupled with an internal combustion engine of a vehicle. The exhaust outlet, in some examples, includes a plurality of openings and a plurality of louvers extending inward from an inner surface of the exhaust outlet.

### BRIEF DESCRIPTION OF THE DRAWINGS

In order that the advantages of the invention will be readily understood, a more particular description of the invention briefly described above will be rendered by reference to specific embodiments that are illustrated in the appended drawings, where like structures and/or components are referred to by like numerals throughout the several views. The drawings shown are not necessarily to scale, with emphasis instead generally being placed upon illustrating the principles of the examples of the subject disclosure. Understanding that these drawings depict only typical embodiments of the subject disclosure and are not therefore to be considered to be limiting of its scope, the disclosure will be described and explained with additional specificity and detail through the use of the accompanying drawings, in which:

FIG. 1 is a schematic block diagram illustrating an exhaust system, according to examples of the subject disclosure;

FIG. 2 is a schematic block diagram of the exhaust system, according to examples of the subject disclosure; and

FIG. 3 is schematic block diagram of the exhaust system, according to examples of the subject disclosure;

FIG. 4 is schematic block diagram of the exhaust system, according to examples of the subject disclosure;

FIG. 5 is a schematic block diagram of a vehicle, according to examples of the subject disclosure

FIG. 6 is a schematic flowchart diagram illustrating a method of manufacturing an exhaust system, according to examples of the subject disclosure;

FIG. 7a is a schematic block diagram of a partial cross-sectional view of the exhaust system, according to examples of the subject disclosure; and

FIG. 7b is a schematic block diagram of the housing, according to examples of the subject disclosure.

### DETAILED DESCRIPTION

Disclosed below is an apparatus, system, and/or method for an improved exhaust system for a land-based vehicle having an exhaust system that may become clogged or blocked due to, for example, environmental objects. While the apparatus, system, and/or method is described below with reference to a snowmobile, the exhaust system may be utilized by other vehicles where an exhaust port may become clogged or where it is desirable to remove excess heat from the exhaust system.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the examples of the disclosure may be practiced without one or more of the specific details, or with other methods, components, materials, and so forth. In other instances, well-known structures, materials, or operations are not shown or described in detail to avoid obscuring aspects of the disclosure.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

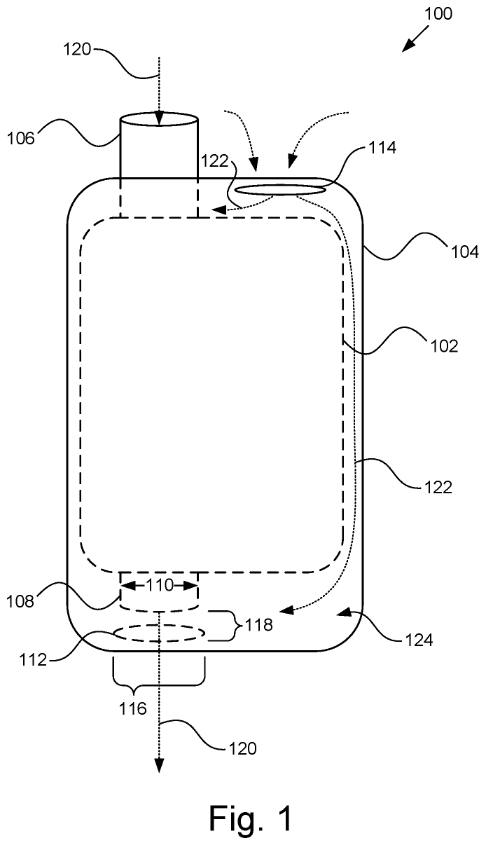

FIG. 1 is a schematic block diagram illustrating an exhaust system 100, according to examples of the subject disclosure. In certain examples, the exhaust system 100 includes a muffler 102 disposed within a housing 104. The muffler 102 may configured to be used with the particular engine application. The muffler 102 has an exhaust inlet 106 and an exhaust outlet 108. The exhaust outlet 108, in certain examples, has a diameter 110.

The muffler 102, in certain examples, is surrounded by the housing 104 (also referred to as “heat shield”). The housing 104 is configured to contain the heat radiating from the muffler 102. In some examples, the housing 104 has a first exhaust opening 112 and a second exhaust opening 114. The first exhaust opening 112, in certain examples, has a diameter 116. The first exhaust opening 112 may be positioned in the housing 104 adjacent the exhaust outlet 108, such that there is a gap 118 having a distance from the exhaust outlet 108. The gap may be measured between an end of the exhaust outlet 108 and a plane defined by the first exhaust opening 112. In other words, the first exhaust opening 112 does not extend to or through the housing 104. This gap allows for exhaust gasses to flow through the housing 104 in the event that the first exhaust opening 112 is blocked. The first exhaust opening 112 may be formed with a shape that conforms to a shape of the exhaust outlet 108. For example, if the exhaust outlet 108 is formed having a substantially circular cross-section (i.e., is tubular in nature), the first exhaust opening 112 may also have a circular cross-section, as depicted in FIG. 1. In other examples, the cross-sectional shapes of the exhaust outlet 108 and the first exhaust opening 112 do not conform.

The diameter 110 of the exhaust outlet 108 and the diameter 116 of the first exhaust opening 112 may be selected to allow for optimal flow between the exhaust outlet 108 and the first exhaust opening 112, such that under normal operating conditions, most of the exhaust gas flows out the first exhaust opening 112. Accordingly, the diameter 116 of the first exhaust opening 112 may be equal to or larger than the diameter 110 of the exhaust outlet 108. In alternative examples, the diameter of the first exhaust opening 112 is smaller than the diameter of the exhaust outlet 108.

In certain examples, the diameter 116 of the first exhaust opening 112 may be about 1.25 to 4 times larger than the diameter 110 of the exhaust outlet 108. Alternatively, the diameter 116 of the first exhaust opening 112 may be about 1.5 to 3 times larger than the diameter 110 of the exhaust outlet 108. Alternatively, the diameter 116 of the first exhaust opening 112 may be about 2 times larger than the diameter 110 of the exhaust outlet 108. Alternatively, the diameter 116 of the first exhaust opening 112 may be about 1.5 times larger than the diameter 110 of the exhaust outlet 108. Altering the diameter of the first exhaust opening 112 may beneficially lead to an increase of draft, or in other words, an increase of ambient air that is drawn through the second exhaust opening 114.

The distance between the exhaust outlet 18 and the first exhaust opening 112 may be selected to allow efficient exhaust flow between the muffler 102 and the housing 104 while providing sufficient distance between the exhaust outlet 108 and the first exhaust opening 112 in the event that the first exhaust opening 112 becomes plugged or blocked. In certain examples, this gap 118 has a distance of between about 0.25 and about 5 inches. In certain examples, the distance may be between about 1 and about 3 inches. In some examples, the distance is about 2 inches.

The exhaust inlet 106 brings exhaust gasses from an internal combustion engine (not shown) into the muffler 102. In an ordinary operating scenario, the exhaust gasses flow through the muffler 102 and out the exhaust outlet 108 and passes through the first exhaust opening 112 as indicated by line 120. This exhaust flow, depicted by line 120, draws ambient air, depicted by lines 122, through the second exhaust opening 114 and into a cavity 124 that is formed between the muffler 102 and the housing 104. This flow 120, creates draw from the second exhaust opening 114, through the housing 104 and out the first exhaust opening 112. Beneficially, this results in cool air being drawn from the external environment and circulated through the housing 104, as indicated by lines 122, which cools the muffler 102 and the entire exhaust system 100. In an enclosed environment such as under a snowmobile hood, this results in a significantly cooler engine compartment. In certain examples, the second exhaust opening 114, may be positioned adjacent to a vent in the hood of the snowmobile to draw in air that is outside of the engine compartment. In applications such as on motorcycles, the draw of cool air may reduce the temperature of the exhaust system 100 and lessen the risk of burns to an operator.

When the engine of the snowmobile or other vehicle is shut off and exhaust is no longer flowing through the exhaust system 100, the direction of the draw may be reversed. The remaining hot air in the system will rise toward and out the second exhaust opening 114, creating a draw that will pull cooler air through the first exhaust opening 112, through the housing 104 and out the second exhaust opening 114.

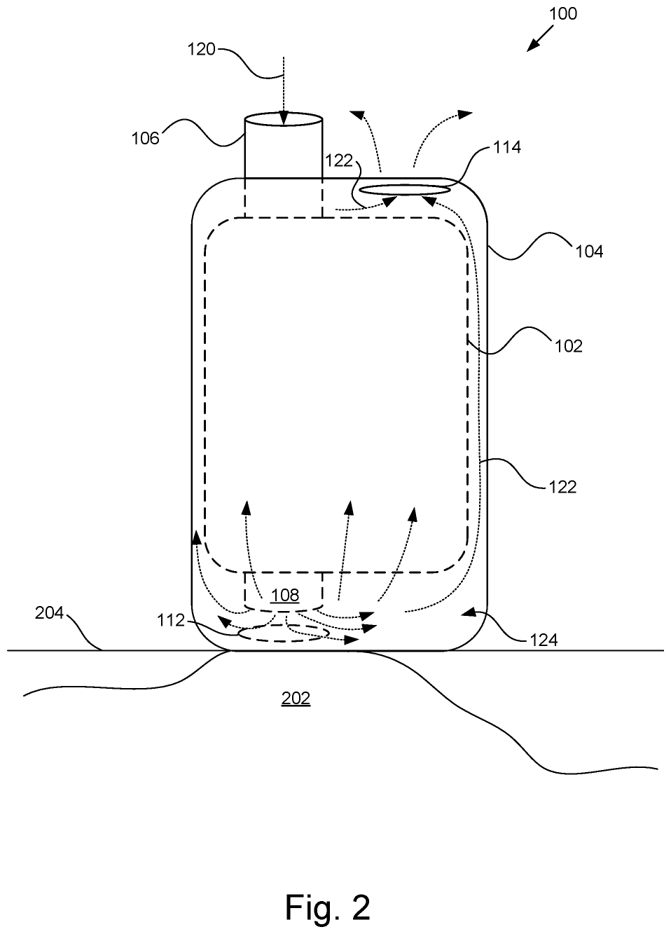

FIG. 2 is a schematic block diagram of the exhaust system 100, according to examples of the subject disclosure. In the depicted embodiment, the exhaust system 100 is positioned such that the first exhaust opening 112 blocked by the terrain 202. Examples of the terrain 202 blocking the first exhaust opening 112 include, but are not limited to, deep snow, sand, dirt, etc. This may occur when a driver of a vehicle (e.g., snowmobile, ATV, etc.) parks in such a way that the terrain 202 makes contact with a body 204 of a vehicle near the first exhaust opening 112. In the depicted example, the housing 104 is positioned adjacent a bottom surface of the body 204 of the vehicle so that exhaust gasses pass through the body 204 and under the vehicle. Other types of blockages are contemplated and may occur regardless of the positioning or orientation of the exhaust system 100 relative to the body 204 of the vehicle.

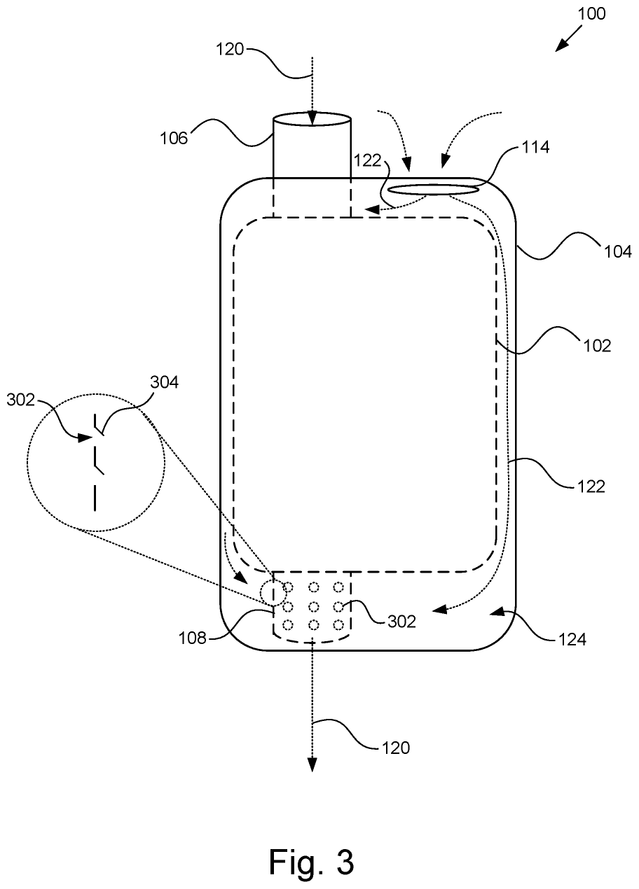

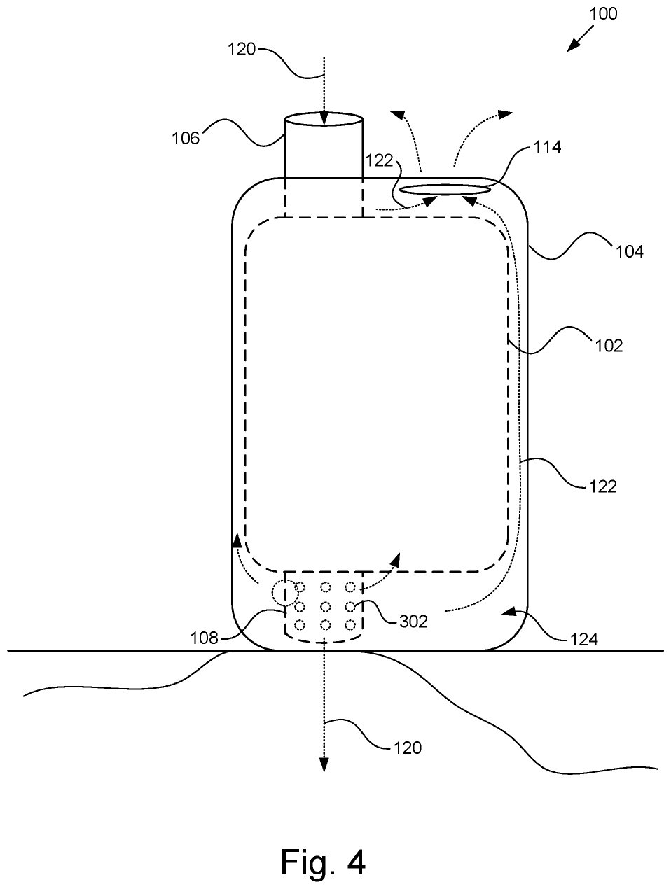

Referring now to FIGS. 3 and 4 jointly, shown therein are schematic block diagrams of the exhaust system 100, according to examples of the subject disclosure. In certain examples, the muffler 102 of the exhaust system 100 conforms to and is configured for a specific engine application. Different engines may require different mufflers 102. Beneficially, the features of the subject disclosure are applicable to any exhaust system 100 that may be blocked during operation. The muffler 102 has an exhaust inlet 106 and an exhaust outlet 108. In the illustrated embodiment, the diameter of the exhaust outlet 108 is not shown, however the concepts of the embodiments of FIGS. 1 and 2 with the concepts of the embodiments of FIGS. 3 and 4 could be combined wherein the diameters of the ports, and the spacing between the ports may be like FIGS. 1 and 2. The muffler outlet 108, in certain examples, may have one or more openings 302. The openings 302 may be fluted or louvered to deflect exhaust flow out the housing 104 in ordinary operating conditions, as depicted by arrow 120. In other words, the exhaust outlet 108 is configured with one or more deflectors 304 or louvers extending inward from an interior wall of the exhaust outlet, as depicted in the callout of FIG. 3.

The muffler exhaust inlet 106 brings exhaust gasses from an internal combustion engine into the muffler 102. In an ordinary operating scenario, the exhaust flows through the muffler 102 and out the exhaust outlet 108 and passes through the housing 104 as indicated by lines 120. This flow 120, creates draw from the second exhaust opening 114, through the heat shield 104 and out the housing 104 through the opening. The draw results in cool air being drawn from the external environment which will cool the muffler 102 and entire exhaust system 100. The flow of the drawn air is indicated by lines 122. In an enclosed environment such as under a snowmobile hood, this may result in a significantly cooer engine compartment. In such applications the second exhaust opening 114, may be positioned adjacent to a vent in the hood of the snowmobile. In applications such as on motorcycles, the draw of cool air may reduce the temperature of the exhaust system 100 and lessen the risk of burns to an operator.

When the engine is shut off and exhaust is no longer flowing through the system 100, the direction of the draw may be reversed. The remaining hot air in the system will rise toward and out the second exhaust opening 114 creating a draw that will pull cooler air through the housing, through holes 304 and out the second exhaust opening 114.

Referring now to FIG. 4, with continued reference to FIG. 3, the example of FIG. 3 is shown with the exhaust being blocked with an obstruction as described above in FIG. 2. In a snowmobile application, the obstruction may be snow but could be other things such as dirt, water, and the like in this and other applications.

The obstruction prevents flow of the exhaust gas out the housing 104. With an obstruction, exhaust gasses will flow through holes 304, to the shield and out the second exhaust opening 114. Once the obstruction is cleared, the exhaust gasses will flow again out the housing 104 and cooling air will be drawn into the second exhaust opening 114 again.

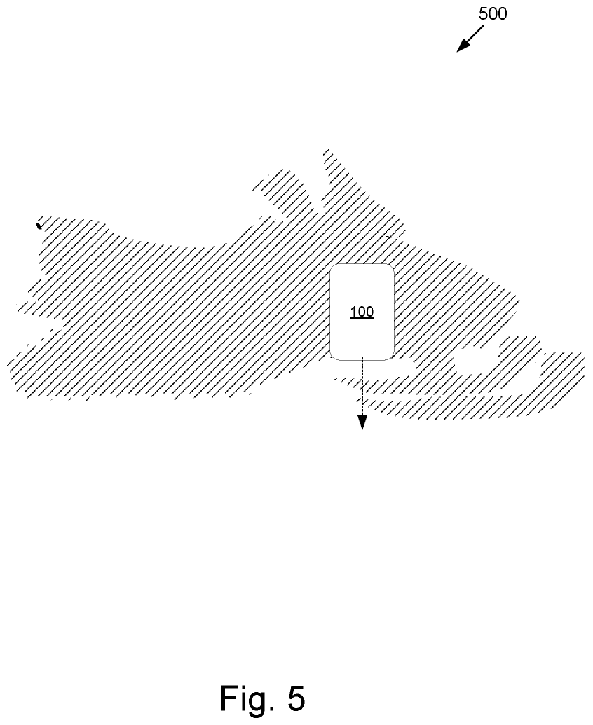

FIG. 5 is a schematic block diagram of a vehicle 500, according to examples of the subject disclosure. The vehicle 500, in certain examples, is a land-going vehicle including, but not limited to, wheel-based vehicles (e.g., cars, trucks, motorcycles, ATVs, etc.), and track-based vehicles (e.g., snowmobiles, snowcats, etc.). In other examples, the benefits and features of the subject disclosure are applicable to water-going vehicles, and any vehicle that may experience a blocked exhaust system, or need additional cooling for the exhaust system. Beneficially, the housing 104 with multiple openings causes ambient air to always flow around the muffler 102, when otherwise the air in the engine compartment might be stagnant. In the depicted embodiment, a snowmobile 500 includes the exhaust system 100. The exhaust system 100 may be positioned adjacent a bottom of the snowmobile 500 so that the first exhaust opening 112 of the housing 104 directs exhaust gasses downward. In other examples, the exhaust system 100 may direct exhaust gasses rearward. When blocked, by snow for example, the gap 118 between the exhaust outlet 108 and the housing 104, or the openings 302, allow for the exhaust gasses to travel upward towards the second exhaust opening 114.

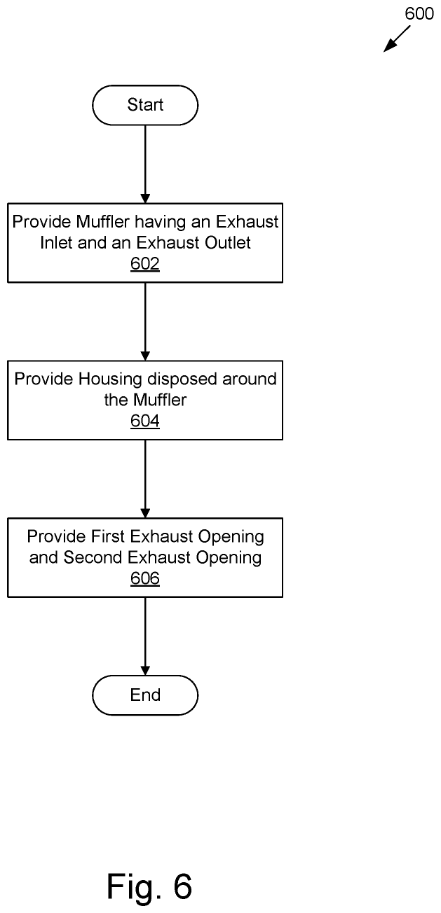

FIG. 6 is a schematic flowchart diagram illustrating a method of manufacturing an exhaust system 100, according to examples of the subject disclosure. In certain examples, the method 600 starts and a muffler 102 is provided at block 602. The muffler 102, in certain examples, includes an exhaust inlet 106 and an exhaust outlet 108. The exhaust inlet 106 is configured to receive exhaust gasses from an internal combustion engine. The exhaust outlet 108 directs the exhaust gasses away from the muffler 102. The muffler 102 may be configured to reduce engine noise. Alternatively, the muffler 102 may be replaced or augmented with a catalytic converter.

At block 604, a housing 104 is provided, and disposed around the muffler 102. The housing 104 may be formed of sheet metal and shaped to fit into an area within an engine compartment. Stated differently, the housing may have a shape that fits into openings defined by other components of the vehicle. At block 606, a first exhaust opening 112 and a second exhaust opening 114 are provided in the housing.

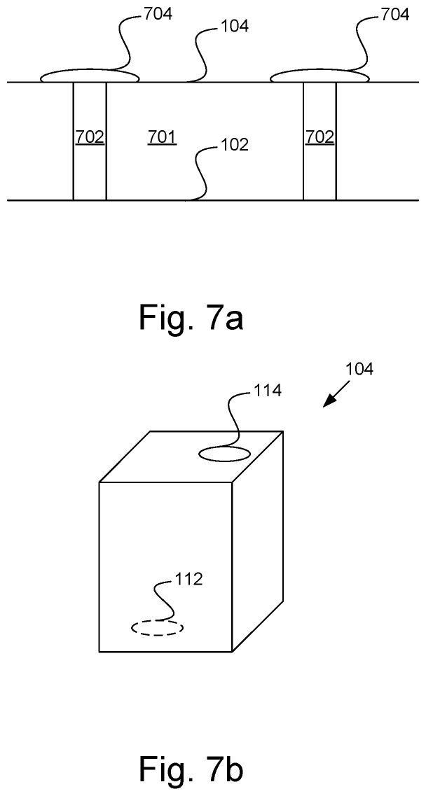

FIG. 7a is a schematic block diagram of a partial cross-sectional view of the exhaust system 100, according to examples of the subject disclosure. In the depicted embodiment, the housing 104 is spaced apart from the muffler 102. In certain examples, a cavity 701 is formed around substantially the entire muffler 102 between the muffler 102 and the housing 104. Standoffs 702 may be provided to maintain the spacing between the housing 104 and the muffler. Fasteners 704, such as a bolt or rivet, may also be provided.

FIG. 7b is a schematic block diagram of the housing 104, according to examples of the subject disclosure. In certain examples, the housing 104 is formed as a generally rectangular shape, although other configurations are contemplated. In certain examples, the first exhaust opening 112 and the second exhaust opening 114 are disposed on opposite faces of the housing 104, such that exhaust gasses are expelled from the housing opposite the second exhaust opening that draws in ambient air, in normal operating mode. In other words, if the first exhaust opening 112 is positioned on a bottom surface of the housing 104, the second exhaust opening 114 may be positioned on a top surface. In other examples, the first exhaust opening 112 is positioned on a planar surface that is adjacent the surface of the second exhaust opening 114. For example, if the second exhaust opening 114 is positioned on the top surface, the first exhaust opening 112 may be positioned on a side surface. In other examples, if the housing has a non-planar configuration (e.g., a sphere or ellipsoid), the first exhaust opening 112 and the second exhaust opening 114 may be positioned to expel gasses in different directions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An exhaust system comprising:
a muffler having an exhaust inlet and an exhaust outlet; and
a housing disposed around the muffler, where the housing comprises:
a first exhaust opening disposed adjacent the exhaust outlet and configured to receive exhaust gasses from the exhaust outlet and direct the exhaust gasses away from the exhaust system in a normal operating mode; and
a second exhaust opening configured to draw in ambient air in the normal operating mode.

2. The exhaust system of claim 1, further comprising a gap between an end of the exhaust outlet and a plane defined by the first exhaust opening.

3. The exhaust system of claim 2, where the gap has a distance in the range of between about 0.25 and about 5 inches.

4. The exhaust system of claim 2, where the gap has a distance in the range of between about 1 and about 3 inches.

5. The exhaust system of claim 2, where the gap has a distance of about 2 inches.

6. The exhaust system of claim 1, where, in a blocked operating mode, the second exhaust opening directs exhaust gasses away from the exhaust system.

7. The exhaust system of claim 1, where the exhaust outlet has a diameter, and the first exhaust opening has a diameter larger than the diameter of the exhaust outlet.

8. The exhaust system of claim 1, further comprising a plurality of standoffs configured to maintain a distance between the muffler and the housing.

9. The exhaust system of claim 1, where the exhaust inlet is fluidly coupled with an internal combustion engine of a vehicle.

10. The exhaust system of claim 9, where the vehicle is a snowmobile.

11. The exhaust system of claim 1, where the exhaust outlet is further configured with a plurality of openings and a plurality of louvers extending inward from an inner surface of the exhaust outlet.

12. A vehicle comprising:
an exhaust system, the exhaust system comprising:
a muffler having an exhaust inlet and an exhaust outlet;
a housing disposed around the muffler, where the housing comprises:
a first exhaust opening disposed adjacent the exhaust outlet and configured to receive exhaust gasses from the exhaust outlet and direct the exhaust gasses away from the exhaust system in a normal operating mode; and
a second exhaust opening configured to draw in ambient air in the normal operating mode.

13. The vehicle of claim 12, further comprising a gap between an end of the exhaust outlet and a plane defined by the first exhaust opening.

14. The vehicle of claim 13, where the gap has a distance in the range of between about 0.25 and about 5 inches.

15. The vehicle of claim 13, where the gap has a distance in the range of between about 1 and about 3 inches.

16. The vehicle of claim 13, where the gap has a distance of about 2 inches.

17. The vehicle of claim 12, where the exhaust outlet has a diameter, and the first exhaust opening has a diameter larger than the diameter of the exhaust outlet.

18. The vehicle of claim 12, where the exhaust inlet is fluidly coupled with an internal combustion engine of the vehicle.

19. The exhaust system of claim 9, where the vehicle is a snowmobile.

20. A method of providing an exhaust system comprising:
providing a muffler having an exhaust inlet and an exhaust outlet; and
providing a housing disposed around the muffler, where the housing comprises:
a first exhaust opening disposed adjacent the exhaust outlet and configured to receive exhaust gasses from the exhaust outlet and direct the exhaust gasses away from the exhaust system in a normal operating mode; and
a second exhaust opening configured to draw in ambient air in the normal operating mode.
